(19) United States
(12) Patent Application Publication
(10) Pub. No.: US 2009/0296370 A1
(43) Pub. Date: Dec. 3, 2009

(54) PHOTO LUMINESCENT LIGHT SOURCE

(76) Inventors: Gregory Nordin, Rohnert Park, CA (US); Robert E. Nondin, Rockaway, NJ (US); Mark S. Pippe, Rohnert Park, CA (US)

Correspondence Address: DERGOSITS & NOAH LLP, Suite 1450, Four Embarcadero Center, San Francisco, CA, 94111, US

(21) Appl. No.: 12/132,524

(22) Filed: Jun. 3, 2008

(51) Int. Cl. F21V 9/16; F21V 23/00; A47F 5/00

(52) U.S. Cl. 362/84; 362/260; 362/125

(57) ABSTRACT

A source of illumination in the form of a base member including hollow members and substantially planar longitudinally extending members. The hollow member is defined by a transparent envelope having an exterior surface and interior surface and photo luminescent pigment applied to a surface thereof or included therein during fabrication. The photo luminescent pigment receives activating energy from ambient sources for its activation.

### TECHNICAL FIELD

The present invention is directed to the field of providing sources of illumination through the activation of a photo luminescent for wide and diverse uses. Such illumination can be employed as an adjunct to or substitute for more conventional electrically-based light sources as well as for use as emergency lighting and signage in the event of a power failure preventing traditional lighting from assisting building occupants.

### BACKGROUND OF THE INVENTION

As energy-related issues become increasing prominent, those involved in the lighting industry are seeking alternatives to traditional sources of illumination. All electrically-based lighting sources either employ electric current distributed from a remotely located power generating station or through batteries, the latter usually restricted to portable or emergency lighting categories. In either case, the generation of power increases carbon dioxide emissions and global warming. Further, as petroleum-based fuels become increasingly expensive, power generation costs increase.

Those faced with concerns such as those addressed above, have sought creative solutions. The compact fluorescent bulb is being turned to as a viable alternative to traditional incandescent lamps. However, such bulbs present their own challenges. For example, compact fluorescent bulbs require mercury to fluoresce and, as a consequence, the potential burden imposed upon landfills and other eco systems could be significant.

Those involved with commercial lighting have not only turned toward low power-consuming bulbs, but having had increasingly employed timers and motion sensors to ensure that lighting is activated only when necessary. However, such solutions are not always reliable and can present significant safety concerns in situations where lighting control results in a lack of illumination at a time when an occupant requires lighting to navigate a premises. Further, many of these alternatives lend themselves to commercial buildings but not to private residences where adoption of sophisticated electronic controls, in the past, have been resisted.

The present application has recognized the need to improve upon previously suggested energy-saving illumination protocols and has now proposed an increasing use of photo luminescents to reduce a good deal of the burden imposed upon energy suppliers to meet current and future lighting needs. The use of photo luminescents is particularly advantageous in that the energy needed to activate a photo luminescent pigment is derived from ambient sources, such as from the sun or traditional incandescent or fluorescent lamps whose energy would otherwise simply be employed for illumination and nothing more.

The present invention recognizes that in emergency situations where primary interior illumination has failed, a reliable source of low level illumination can be beneficial. Also, although interior lighting of high intensity is oftentimes needed, it is not always needed to the full extent provided by traditional sources. Regarding the use of photo luminescents as an emergency light source, applicant has suggested such use in its U.S. application Ser. No. 12/048,974, filed on Mar. 14, 2008, the disclosure of which is incorporated by reference herein.

Further, there are situations in which incandescent or fluorescent lighting may not always be needed. For example, when workers are engaged with their computers, high-energy background lighting can often times wash out or obscure a computer screen. In other words, although it may be preferable to provide high intensity traditional lighting when a building occupant wishes to read text from written documents, such lighting is not only not necessary but can be a detriment when working at a computer terminal. Being able to extinguish traditional lighting and rely upon photo luminescents which have been activated from ambient sources would not only save energy but could actually be viewed as an enhancement to the working environment.

It is thus an object of the present invention to provide photo luminescent lighting sources as an alternative to traditional lighting in order to save energy and provide a more desirable work space. These and further objects will be more readily apparent when considering the following disclosure and appended claims.

### SUMMARY OF THE INVENTION

The present invention is directed to a source of illumination comprising either a hollow member or a base member, the former defined by a substantially transparent envelope and the latter as a strip of material having a width and length. Each member is provided with a longitudinal axis and a photo luminescent pigment capable of receiving energy for its activation and for the generation of light energy through photo luminescence.

### BRIEF DESCRIPTION OF THE FIGURES

FIG. 1 is a perspective view of a first embodiment of the present invention.

FIG. 2 is a cross-sectional view of the embodiment of FIG. 1 taken along line 2-2 thereof.

FIG. 3 is a perspective view of a hanging light fixture capable of employing the present invention.

FIG. 4 is a perspective view of yet another embodiment to the present invention.

FIG. 5 is a side view of yet a further embodiment of the present invention employing the embodiment of FIG. 4 in a commercial product.

FIG. 5A is a cross sectional view of a portion of the embodiment of FIG. 5 along line 5A-5A.

FIG. 6 is a perspective view of a further embodiment of the present invention.

### DETAILED DESCRIPTION OF THE INVENTION

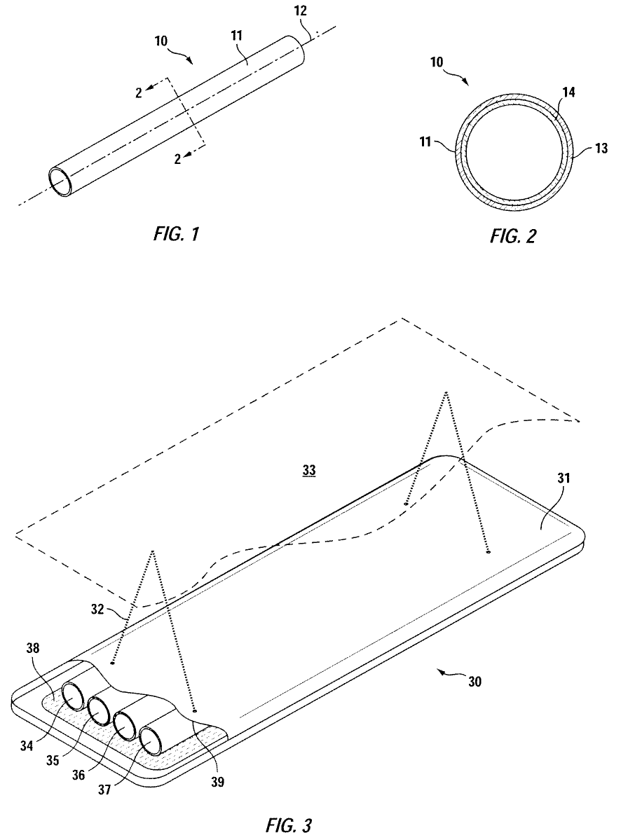

As noted, the present invention involves creating a source of illumination through the use of a photo luminescent pigment supported on or within a substrate. The photo luminescent pigment can be applied as an ink layer or in a binder or adhered to a glue tape or film or molded within and made part of the substrate. A first embodiment of such invention is depicted in FIGS. 1 and 2.

Turning first to FIG. 1, source of illumination 10 is disclosed comprising hollow member 11 composed of, for example, glass or plastic which is substantially transparent to the passage of energy in the form of ambient light to activate photo luminescent pigment layer 13 and light energy created by photo luminescent pigment layer 13 there from.

As noted in reference to FIG. 2, ideally, substantially transparent envelope 11 is first coated with photo luminescent pigment layer 13 and thereupon, coated with white pigment layer 14 to enhance visibility of the photo luminescent material. Appropriate photo luminescent materials as well as their application to suitable substrates is disclosed in applicant's co-pending U.S. application Ser. No. 12/048,974, filed on Mar. 14, 2008, the disclosure of which is incorporated by reference herein.

It is noted that source of illumination 10, as depicted in FIG. 1, ideally comprises a cylinder having longitudinal axis 12 and a substantially circular cross-section. Once the photo luminescent layer 13 and white pigment backing layer 14 are applied to the interior surface of transparent envelope 11, the cylinder ideally remains evacuated of any solid material. Alternatively, it can be made to receive a packing material.

In use, the photo luminescent material of the present invention, regardless of its embodiment, can be activated by placing the present invention in a location to receive ambient light energy. Such energy activates the photo luminescent pigment and causes it to discharge light energy of its own. Thus, for example, cylindrical member 10 can be applied by simply hanging it from an appropriate ceiling, or used in other ways to either provide light to an interior space or for other purposes, such as emergency illumination.

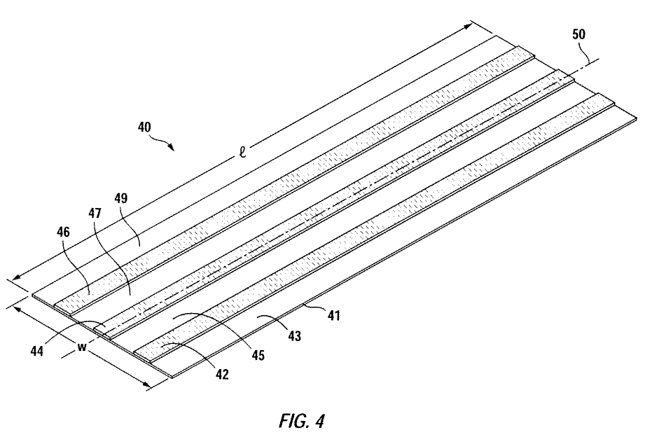

As an illustration of the flexibility of the present invention, reference is made to FIG. 3. In this instance, housing 30 is provided in the form of a somewhat standard looking fluorescent lighting fixture having multiple tubular fluorescent elements contained therein. Such a fixture includes a shell 31 hung from ceiling 33 through the use of cords, chains or cables 32. Interior concave surface 39 is ideally coated with a reflector to enhance the output of fixture 30 and, as noted, multiple bulbs are contained therein energized by a starter and AC power source (not shown).

In applying the embodiment of FIG. 3 to the present invention, it is contemplated that some of the tubular elements be standard fluorescent bulbs while others are photo luminescent elements such as depicted in FIG. 1. Thus, bulbs 35 and 36 can be standard fluorescent elements while bulbs 34 and 37 are photo luminescent elements of the present invention. In operation, as long as lighting unit 30 is powered on, fluorescent bulbs 35 and 36 would generate light as they normally would. However, either in an emergency situation in which power is lost or in order to save energy or for any other purpose, when lighting fixture 30 is powered off, photo luminescent elements 34 and 37 would provide visible light to its surrounding space. The clear advantage of such an embodiment is that as long as fluorescent bulbs 35 and 36 are activated, activating energy is being received by the photo luminescent coated within cylindrical elements 34 and 37 so that they are in a position to generate visible light immediately upon the powering down of the corresponding fluorescent elements.

As an illustration of the use of lighting 30, an occupant could turn the fluorescent elements 35 and 36 on while reading or doing fine work requiring substantial light. However, if this same user was to begin word processing or similar computer-related endeavors, the visible light energy available from photo luminescent elements 34 and 37 may be ideal as providing sufficient lighting for this purpose while expending no further electrical energy in the process.

As a further embodiment to the present invention, reference is made to FIG. 4. As an alternative to the embodiment of FIGS. 1 and 2, FIG. 4 illustrates a substantially planar base member having a width (w) and a length (l) and longitudinal axis 50. Source of illumination 40 is ideally configured having a rectangular planar surface although other geometries can be employed while remaining within the spirit and scope of the present invention.

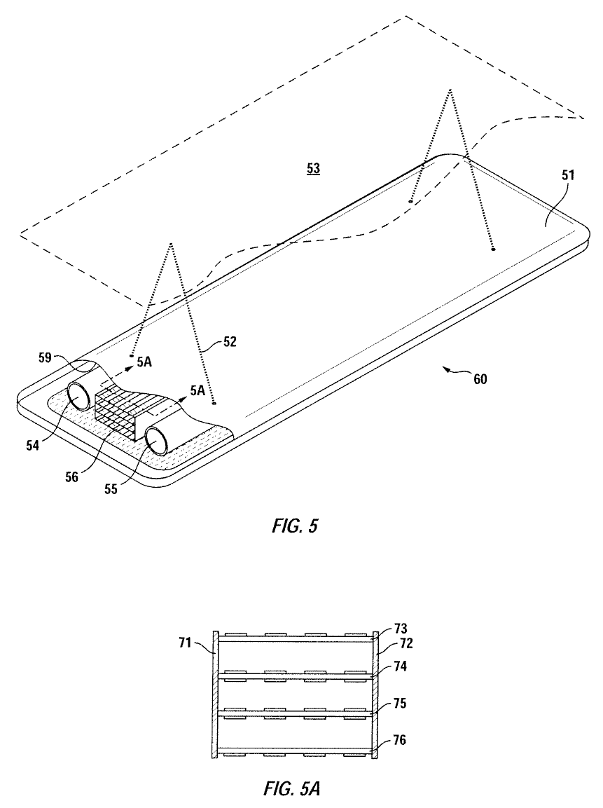

Source of illumination 40 includes base member 41 which is ideally a transparent material such as Lexan® or any other suitable plastic or glass member. Base member 41 can employ a uniform coating of a photo luminescent preceded by the application of a white pigment as discussed previously. The planar member can then be employed in the same fashion as described with respect to cylindrical member 10 either alone or contained within a lighting fixture (FIG. 5).

As a preferred embodiment, base member 41 can be coated with strips 42, 44 and 46 of a photo luminescent, either alone, or preceded by the application of a white pigment, leaving transparent strips 43, 45, 47 and 49 there between. The actual number of strips is a matter of design choice. Further, strips can be applied to one side or to both sides of each base member while remaining within the scope of the present invention. As an example of the embodiment shown in FIG. 4, reference is made to FIG. 5.

The embodiment of FIG. 4 can be employed in a light fixture and used similarly to fixture 30 of FIG. 3. Specifically, fixture 60 containing standard fluorescent bulbs 54 and 55 in housing 51 is shown. However, in this instance, planar array 56 having four planar elements, all fabricated as discussed and shown with regard to FIG. 4, is positioned within lighting fixture 60 so that the longitudinal axis of the array is parallel to the longitudinal axes of fluorescent bulbs 54 and 55. As in the illustration of FIG. 3, housing 51 is provided in the form of a somewhat standard looking fluorescent lighting fixture having multiple tubular fluorescent elements contained therein. Such fixtures include a shell hung from ceiling 53 through the use of cords, chains, or cables 52. Interior concave surface 59 is ideally coated with a reflector to enhance output of fixture 60 and, as noted, multiple bulbs 54 and 55 are contained therein energized by a starter and AC power source (not shown).

In operation, as long as lighting unit 60 is powered on, fluorescent bulbs 54 and 55 would generate light as they normally would. However, either in an emergency situation in which power is lost in order to save energy for any other purpose, when lighting fixture 60 is powered off, photo luminescent array 56 would provide visible light to its surrounding space. As long as fluorescent bulbs 54 and 55 are activated, activating energy is received by photo luminescent array 56 so that the photo luminescent contained on their planar supports generate visible light immediately upon the powering down of corresponding fluorescent elements.

Clearly, the embodiment of FIG. 5 is depicted as a mere illustration of one embodiment to the present invention. Other geometrical configurations are certainly possible while remaining within the spirit and scope of the present invention. In each instance, the photo luminescent layer can be backed with a white pigment layer. In addition, photo luminescent strips can be configured on one or both sides of the various base members while again remaining within the spirit and scope of the present invention. A typical configuration of multi-stack array 56 is shown in FIG. 5A. As noted, spacers 71 and 72 maintain base members 73, 74, 75 and 76 apart and parallel to one another. In this example, outer base members 73 and 76 are coated with a photo luminescent only on their outer surfaces while inner base members 74 and 75 are coated on both sides.

As noted above, the photo luminescent pigment can be incorporated within a suitable substrate during its fabrication and need not be applied as an ink or a silkscreened layer. In each of the embodiments discussed previously, the suitable substantially transparent support be it tubular or as a planar strip can be molded, such as through an injection molding process, with the photo luminescent pigment applied to the support during fabrication.

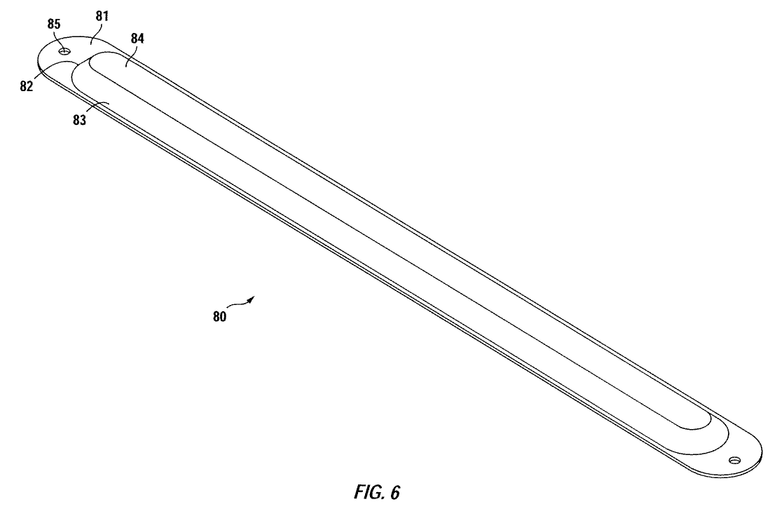

Turning now to FIG. 6, a further commercial embodiment of the present invention is depicted. In this instance, photo luminescent light source 80 contains a base material 81 which is preferably transparent or at least translucent. During fabrication, field 82 is created during which time a photo luminescent pigment is incorporated within the injection molded process producing light source 80 and creating photo luminescent source 84 dispersed within the body of photo luminescent light source 80 only partially within field 82 leaving field 83 transparent or translucent to light energy. Such a product can be used as a stand alone item by hanging or otherwise attaching photo luminescent light source 80 through the use of openings 85 or can be stacked as alternatives to element 73-76.

If photo luminescent light source 80 is to be used as signage, because photo luminescent pigment region 84 is uniformly distributed as shown in FIG. 6, signage indicia would be created by masking portions of field 84 to create the appropriate messaging.

Applicant previously filed U.S. application Ser. No. 12/048,974 which discusses the use of photo luminescence for emergency purposes and as indicators of exits which may not be otherwise visible if power is lost within a building. The present invention could be used for the same purpose. For example, the various photo luminescent elements discussed above could be applied to base boards to indicate a direction of travel to find the closest exit. Yet a further use of the present invention would be to apply the disclosed photo luminescent elements on the frame of an emergency exit door to again indicate to building inhabitants a suitable exit for leaving in an emergency situation. Conversely, a photo luminescent could be applied to a support either during fabrication or as an add on layer uniformly, while information, such as emergency exit indicia, is masked from view to provide the negative image of the signage suggested in applicant's previously filed '974 application. There are certainly a myriad of other uses of this invention other than those described above which would clearly be apparent to anyone of ordinary skill in this art.

What is claimed is:

1. A source of illumination comprising a hollow member, said hollow member being defined by a substantially transparent envelope, said envelope having an exterior surface and an interior surface and a photo luminescent layer applied to at least one of said surfaces, or incorporated within said substantially transparent envelope, said hollow member being capable of receiving energy through said envelope for activating said photo luminescent layer.

2. The source of illumination of claim 1 further comprising a white pigment layer applied as a backing to said photo luminescent layer.

3. The source of illumination of claim 1 wherein said hollow member comprises a cylinder having a longitudinal axis and a substantially circular cross section.

4. The source of illumination of claim 1 wherein said energy is supplied by ambient light.

5. The source of illumination of claim 3 wherein said energy is supplied by at least one fluorescent lamp.

6. The source of illumination of claim 5 wherein said photo luminescent lamp comprises a cylinder having a longitudinal axis situated substantially parallel to the longitudinal axis of said hollow member.

7. A source of illumination comprising a housing having a length and cross sectional area, said length having a housing longitudinal axis and means to secure at least one hollow member therein, at least one hollow member being defined by a substantially transparent envelope, said envelope having an exterior surface and an interior surface, and a photo luminescent layer applied to at least one of said surfaces, or incorporated within said substantially transparent envelope, said hollow member being capable of receiving energy through said envelope for activating said photo luminescent layer whereupon light emanating from said photo luminescent layer is visible from a position exterior to said housing.

8. The source of illumination of claim 7 wherein said hollow member comprises a cylinder having a longitudinal axis and a substantially circular cross section.

9. The source of illumination of claim 8 wherein said housing longitudinal axis is approximately parallel to the longitudinal axis of said hollow member.

10. The source of illumination of claim 9 further comprising at least one fluorescent lamp secured within said housing having a longitudinal axis and substantially circular cross section, said longitudinal axis of said fluorescent lamp being substantially parallel to the longitudinal axis of said hollow member.

11. The source of illumination of claim 7 wherein said housing further comprises a substantially transparent cover provided for the passage of activating energy to and from said photo luminescent layer.

12. An emergency source of illumination comprising a hollow member, said hollow member being defined by a substantially transparent envelope, said envelope having an exterior surface and an interior surface and a photo luminescent layer applied to at least one of said surfaces, or incorporated within said substantially transparent envelope, said hollow member being capable of receiving energy through said envelope for activating said photo luminescent layer wherein light emitted from said hollow member is visible upon termination of said energy.

13. The emergency light source of illumination of claim 12 wherein said hollow member is positioned to illuminate the exit from an interior space.

14. The emergency source of illumination of claim 13 wherein said hollow member is affixed to a base board.

15. The emergency source of illumination of claim 14 wherein said hollow is affixed to a door frame.

16. A source of illumination comprising at least one base member having a width and length and longitudinal axis extending throughout said length, said at least one base member being substantially transparent to visible light and having a photo luminescent pigment coated on or incorporated therein, said least one base member positioned to receive visible light for activation of said pigment.

17. The source of illumination of claim 16 wherein portions of said base member contain photo luminescent pigment while others areas are free thereof.

18. The source of illumination of claim 17 wherein at least one base member is positioned within a lighting fixture and being capable of receiving energy therein for activating said photo luminescent layer.

19. The source of illumination of claim 18 wherein a plurality of base members are positioned within said lighting fixture.

20. The source of illumination of claim 19 wherein said plurality of base members extend within said lighting fixture and oriented such that each of their longitudinal axes are substantially parallel to one another and wherein said plurality of base members are spaced from one another therein.

21. The source of illumination of claim 19 wherein said lighting fixture has a length and cross-sectional area, said length having a fixture longitudinal axis and means to secure said at least one base member therein, such that light emanating from said photo luminescent pigment is visible from a position exterior to said fixture.

22. The source of illumination of claim 21 wherein said fixture longitudinal axis is approximately parallel to the longitudinal axis of said base member.

23. The source of illumination of claim 22 further comprising at least one fluorescent lamp secured to within said housing having a longitudinal axis and substantially circular cross-section, said longitudinal axis of said fluorescent lamp being substantially parallel to the longitudinal axis of said base member.

24. The source of illumination of claim 23 wherein said housing further comprises a substantially transparent cover provided for the passage of activating energy to and from said photo luminescent layer.

25. The source of illumination of claim 16 wherein said photo luminescent pigment is incorporated in said base member during its fabrication.

26. The source of illumination of claim 25 wherein said base member comprises a plastic formed by injection molding with said photo luminescent pigment incorporated therein.

27. A sign for messaging comprising a base member and a photo luminescent pigment applied to or incorporated therein, said photo luminescent pigment being selectively visible from said sign to provide said messaging to an observer thereof.

28. The sign of claim 27 wherein said photo luminescent pigment is selectively incorporated within said base member.

29. The sign of claim 27 wherein said photo luminescent pigment is uniformly dispersed within said base member, portions of which are masked to provide said messaging.
